(19) United States
(12) Patent Application Publication
(10) Pub. No.: US 2007/0256883 A1
(43) Pub. Date: Nov. 8, 2007

(54) Toothed belt Gearing

(76) Inventors: Martin Budaker, Heubach (DE); Stefan Froehlich, Zimmerbach (DE); Klaus-Dieter Leimbach, Eschach (DE); Wolfgang Reuter, Florstadt (DE); Ralf Duschek, Weitmars (DE); Detlef Beck, Goeggingen (DE); Andreas Lay, Schwaebisch Hall (DE); Torsten Hesse, Moegglingen (DE); Michael Yankonis, Schechingen (DE)

Correspondence Address: JORDAN AND HAMBURG LLP, 122 EAST 42ND STREET, SUITE 4000, NEW YORK, NY, 10168, US

(21) Appl. No.: 11/271,476

(22) Filed: Nov. 10, 2005

(30) Foreign Application Priority Data
Nov. 25, 2004 (DE) 10 2004 056 878.2

(51) Int. Cl. B62D 5/04; B62D 3/00; F16H 7/02

(52) U.S. Cl. 180/400; 180/444; 474/153

(57) ABSTRACT

A toothed belt gearing includes a toothed pulley including pulley teeth having a first configuration and a toothed belt including belt teeth having a second configuration. The belt teeth are meshable with the pulley teeth, the first configuration and the second configuration being different from one another and being selected so as to minimize air present in tooth spaces between meshed ones of the belt and pulley teeth as compared to other toothed belt and pulley combinations which share a substantially same tooth configuration, thereby reducing noise radiation resulting from a resonance behavior of the toothed belt normally present in the other toothed belt and pulley combinations.

### BACKGROUND OF THE INVENTION

The invention relates to a toothed belt gearing in particular for a motor vehicle power steering system.

A toothed belt gearing for electric power steering of a motor vehicle can be found in DE 100 52 275 A1, whereby a motor shaft of an electric servo motor carries a first toothed belt pulley. A second toothed belt pulley is connected rotation-fast to a gear arrangement, such as a ball nut, that converts its rotational movement to an adjusting movement of a spindle and thus of a displaceable component of the gear arrangement. One wheel of the motor vehicle can be connected in a known manner using its steering angle adjuster with a tie rod and a wheel linkage lever with gearing to the displaceable component. With its profile that fits the circumference-side of the toothed belt pulleys, a toothed belt runs on the first and second toothed belt pulleys and transmits the torque and the speed of the motor shaft of the servomotor to the gear arrangement in a positive fit and play-free.

Noise emissions in such a toothed belt gearing are not minimized.

DE 31 46 945 C2 provides the designer of toothed belt gearings a dimensioning rule in order to select the geometric parameters of the tooth flank surfaces of the toothed belts or the tooth profile of a toothed belt, such as somewhat rounded head surfaces of teeth, such that the transferable load is maximized or the running noise of a toothed belt is reduced by the selection of an appropriate tooth head profile. For noise reduction, it is proposed that the head surfaces of the teeth on toothed belts are rounded.

DE 198 36 897 A1 describes a toothed belt and a toothed belt gearing with low wear and reduced noise. The toothed belt is distinguished by teeth whose pitch matches the teeth on standard gears. Furthermore, the tooth depth in the toothed belt is determined such that the teeth in the toothed belt extend radially inward across the reference circle diameter of the gear into the intermediate spaces of the gear. What this attains is that the gear engages and disengages with the toothed belt in a rolling motion that is associated with less friction and less wear. A rolling motion on an input and output of the toothed belt on the gear is possible when using standard gears. This minimizes wear and noise.

The dissertation entitled “Geräuschverhalten und Geräuschminderung von Zahnriementrieben” [Noise and Noise Reduction in Toothed Belt Drives], U. Jansen, T U Aachen, Fortschritt-Berichte VDI No. 136, concerns systematic research into possible causes of noise in toothed belt drives and weights them into relevant and less relevant causes. Noise emissions were examined as a function of a large number of design and operating parameters. The dissertation demonstrates that the speed of toothed belt pulleys and the belt width surpassed all other factors in terms of design and operating parameters of toothed belt drives. Toothed belt width determines the frequency range in which the sound energy is radiated. As belt width increases, the frequency of maximum level drops. Causes for operating noise in toothed belt drives are tooth meshing shock, toothed belt transversal vibrations, air flowing out of the meshing tooth spaces, speed and belt speed, and tooth meshing frequency. Significantly higher levels are measured on toothed belt pulleys compared to the free part of the belt, which, with the exception of belt resonance, can be largely excluded as a radiating element.

The relevant levels occur immediately at the belt inlet, whereby there is no notable difference between input drive side and output drive side of the toothed belt. The toothed belt noise is primarily caused by the toothed belt striking the pulley when the driving toothed belt pulley meshes, but, as new investigations prove, is also caused by structure-borne noise. Tooth flank friction has a damping effect. The impact noise of the toothed belt is explained by a polygon effect. The contact between toothed belt and toothed pulley is periodically interrupted in the geometric tangent point by the teeth, which means a radial component of the relative speed can be formed between the toothed belt and the toothed belt pulley. When meshing, the toothed belt has a downward movement to the axis of rotation of a toothed belt pulley and a tooth on the toothed belt pulley has an upward movement in the radial direction away from the axis of rotation of the toothed belt pulley. Impact speed is the differential vector between the radial speeds of toothed belt and toothed belt pulley. Impact speed is a function of speed and tooth pitch, but is largely independent of the number of teeth and the size of the toothed belt pulley used. The special feature in toothed belt pulleys is that harmonics of the tooth meshing frequency excite the air that is enclosed in the tooth spaces to sympathetic vibrations during belt run-in. Hollow resonances of the air volume in the teeth are immediately radiated as airborne sound at high levels at the site of the tooth meshing. In terms of reducing noise level, the impact can be dampened or measures can be undertaken that counteract the effect of the air that travels into the hollow structure. For effective noise reduction, the dissertation suggests a longitudinal groove in the toothed belt and the use of a soft nonwoven belt covering or polyamide cover on the surfaces of the toothed belt.

### SUMMARY OF THE INVENTION

An object of the invention is to provide effective noise damping measures on toothed belt gearings that can be realized in a simple manner.

Since a toothed belt gearing is created with a toothed belt and at least one toothed belt pulley, whereby a pitch difference is created in that the toothed belt pulley has a different, preferably slightly different, pitch then the toothed belt and/or the toothed belt pulley has helical teeth and the toothed belt has straight teeth and/or the toothed belt pulley has a slightly different helix angle or approximately the same helix angle for its teeth as the helix angle for the toothed belt, it is avoided that as the toothed belt runs in there is air in tooth spaces of the gear, thus causing hollow resonances of the air volume, and also avoided is a different, asymmetrical, and/or alternating tensile stress distribution in the toothed belt, which means that the resonance behavior of the toothed belt in terms of its noise radiation is positively affected and structure-borne noise is minimized. The pitch is the distance between two level tooth flanks on the pitch circle, whereby a difference in the pitch of toothed belt pulley to toothed belt can also be adjusted using a slight longitudinal tolerance of the toothed belt. The helix angle of a helical gear or helical toothed belt pulley is the acute angle that the tangents on the helical line includes with the generating line and the point of contact.

The teeth of the toothed belt in the execution of each of the suggested designs and in all of the suggested designs for noise damping run with their flanks not only radially but also in the axial direction to the toothed belt pulley on the tooth flanks of the toothed belt pulley, or, as with the helical teeth of toothed belt pulley and toothed belt, there are a plurality of teeth in contact. This means that in addition to a soft, limited-friction contact of the tooth flanks of the toothed partner, it is possible for air to escape from the tooth spaces in the toothed belt pulley in the axial direction of the toothed belt pulley, which reduces hollow resonances. In addition, the tensile strength distribution with the toothed belt width is asymmetrical and/or alternating. Occurrences of resonance in the toothed belt are minimized in this manner in terms of their effect on the operating noise of the toothed belt gearing.

In order to make possible a non-uniform tensile strength distribution across the width of the toothed belt during operation of the toothed belt gearing, the axes of the first toothed belt pulley and of a second toothed belt pulley on which the toothed belt runs are placed at an angle to one another, in the sense of slightly non-parallel axes. The acute angle that the axes of the first and second toothed belt pulleys assume to one another is approximately 0.2° to 0.5° in one particularly preferred embodiment of the toothed belt gearing.

It can be useful to effect the desired tooth meshing and/or the desired tension distribution in the toothed belt using preferably slightly helical teeth in the toothed belt that run on straight-toothed belt pulleys. The helix angle on the first toothed belt pulley can be the inverse of or equal to the helix angle on the second toothed belt pulley. In combination with one or a plurality the of the aforesaid inventive features of the toothed belt gearing, the tooth shape can be selected convex or semicircular or parabolic on the toothed belt. The soft running of toothed belt teeth into the tooth spaces of the toothed belt pulley can also be effected using the teeth on the back of the toothed belt. For axial securing of the toothed belt, it makes sense to arrange a thrust washer or a shoulder ring on at least one toothed pulley, preferably integral with the toothed pulley, or to arrange two thrust washers on the toothed belt pulley of the motor shaft of the servo motor.

The toothed belt gearing described is suitable for use in power steering systems, whereby a toothed belt pulley preferably drives a ball nut of a recirculating ball gear. The recirculating ball gear drives a displaceable component that is connected to a steered wheel of the motor vehicle for its steering angle adjuster. The toothed belt gearing is preferably part of an electric power steering system for a passenger vehicle or a light utility vehicle.

The invention will now be described in greater detail using an exemplary embodiment and will be illustrated using the drawing.

### IN THE DRAWING

FIG. 1 is a schematic longitudinal segment through a recirculating ball gear with a toothed belt gearing of a vehicle.

### DESCRIPTION OF THE PREFERRED EMBODIMENTS

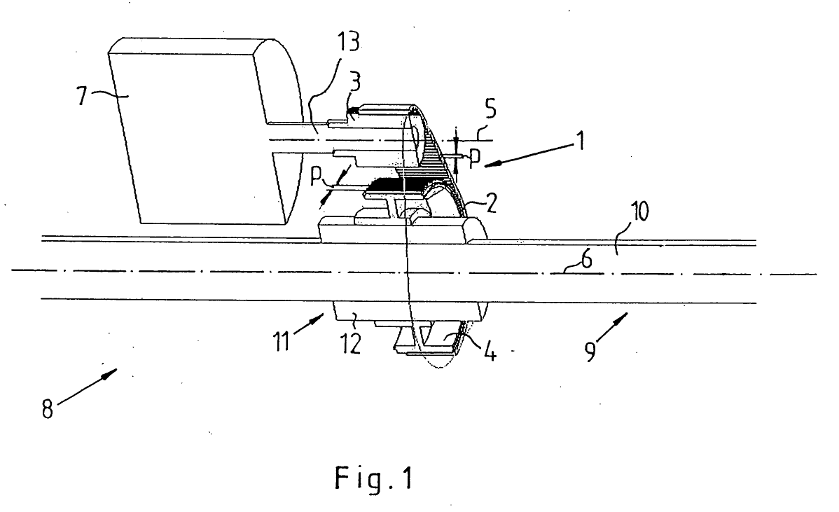

FIG. 1 illustrates a longitudinal segment of an electric power steering system 8 that is largely formed by an operable ball gear 11 with a ball nut 12 that is rotatably arranged about a displaceable component 9 embodied as a threaded spindle 10. The threaded spindle 10 is moved in the axial direction during rotation of the ball nut 12. One or a plurality of steerable wheels of the vehicle can be pivoted as a result. Fixed on the axially immovably borne ball nut 12 is a second toothed belt pulley 4 that is slip-free and in a positive fit, via a toothed belt 2, with a first toothed belt pulley 3 of a toothed belt gearing 1. The first toothed belt pulley 3 is seated rotation-fast on a motor shaft 13 of an electric servo motor 7. The toothed belt pulleys 3, 4 and the toothed belt 2 form the toothed belt gearing 1.

An axis 6 of the second toothed belt pulley 4 is congruent with the axis of the displaceable component 9 and the threaded spindle 10. In the illustrated exemplary embodiment, the axis 5 of the first toothed belt pulley 3 is arranged parallel to the axis 6 of the second toothed belt pulley 4, but it can also be arranged at a slight angle of approximately 0.2° to 0.5° to the axis 6 of the second toothed belt pulley 4. The pitch p of the first toothed belt pulley 3 and of the second toothed belt pulley 4 is slightly different, for instance by 0.02 mm to 0.2 mm, to the pitch of the toothed belt 2, resulting in the teeth of the toothed belt 2 running into tooth spaces of the toothed belt pulleys 3, 4 in a soft, dampened manner, and thus resulting in a reduction in noise for the toothed belt gearing 1.
1 Toothed belt gearing
2 Toothed belt
3 First toothed belt pulley
4 Second toothed belt pulley
5 Axis
6 Axis
7 Servo motor
8 Steering system
9 Displaceable component
10 Threaded spindle
11 Recirculating ball gear
12 Ball nut
13 Motor shaft
p Pitch

1-13. (canceled)

14. A toothed belt gearing, comprising:
a toothed pulley including pulley teeth having a first configuration;
a toothed belt including belt teeth having a second configuration, said belt teeth being meshable with said pulley teeth, said first configuration and said second configuration being different from one another and being selected so as to minimize air present in tooth spaces between meshed ones of said belt and pulley teeth as compared to other toothed belt and pulley combinations which share a substantially same tooth configuration, thereby reducing noise radiation resulting from a resonance behavior of said toothed belt normally present in said other toothed belt and pulley combinations.

15. A toothed belt gearing according to claim 14, further comprising an other toothed pulley, said toothed pulley rotating about a first axis and said other pulley rotating about a second axis which is non-parallel to said first axis.

16. A toothed belt gearing according to claim 15, wherein said first axis is disposed at an angle relative to said second axis which is in a range of about 0.2° to about 0.5°.

17. A toothed belt gearing according to claim 14, wherein:
said pulley teeth having said first configuration are configured to include a first pitch; and
said belt teeth having said second configuration are configured to include a second pitch different from said first pitch.

18. A toothed belt gearing according to claim 14, wherein:
a one of said pulley teeth and said belt teeth is configured to include helical teeth; and
a remaining one of said pulley teeth and said belt teeth is configured to include straight teeth.

19. A toothed belt gearing according to claim 14, wherein:
said pulley teeth are configured to include helical teeth having a first helix angle; and
said belt teeth are configured to include helical teeth having a second helix angle different from said first helix angle.

20. A toothed belt gearing according to claim 14, wherein said toothed belt is configured to include helical teeth.

21. A toothed belt gearing according to claim 20, further comprising an other toothed pulley having other pulley teeth, said pulley teeth and said other pulley teeth being configured as helical teeth, said pulley teeth having a helix angle and said other pulley teeth having an other helix angle inverse to said helix angle.

22. A toothed belt gearing according to claim 14, wherein at least a portion of said belt teeth includes a convex tooth shape.

23. A toothed belt gearing according to claim 14, wherein at least a portion of said belt teeth includes a semicircular tooth shape.

24. A toothed belt gearing according to claim 14, wherein at least a portion of said belt teeth includes a parabolic tooth shape.

25. A toothed belt gearing according to claim 14, further comprising additional teeth which are carried on a back of said toothed belt, said additional teeth being one of straight and helical.

26. A toothed belt gearing according to claim 14, wherein said toothed pulley includes a shoulder ring.

27. A toothed belt gearing according to claim 14, further comprising a servomotor of a power steering system for driving the toothed belt gearing.

28. A toothed belt gearing according to claim 27, further comprising a displaceable component of a gearing, said servomotor driving said displaceable component via the toothed belt gearing, whereby the displaceable component is connected to a steerable wheel.

29. A toothed belt gearing according to claim 28, further comprising a recirculating ball gear on a ball nut to which said toothed belt pulley is affixed, said displaceable component including a threaded spindle that is driven via said recirculating ball gear on said ball nut.

30. A toothed belt gearing according to claim 14, wherein the toothed belt gearing is part of an electric power steering system for a motor vehicle.

31. A toothed belt gearing according to claim 17, wherein said first pitch differs from said second pitch by an amount in a range of about 0.02 mm to about 0.2 mm.
